(19) United States
(12) Patent Application Publication
(10) Pub. No.: US 2003/0055443 A1
(43) Pub. Date: Mar. 20, 2003

(54) Tripod knife for venous access

(76) Inventor: Henry M. Spotnitz, New York, NY (US)

Correspondence Address: Reed Smith LLP, 599 Park Avenue, New York, NY, 10022, US

(21) Appl. No.: 10/188,344

(22) Filed: Jul. 1, 2002

Related U.S. Application Data
(60) Provisional application No. 60/302,411, filed on Jun. 29, 2001.

(51) Int. Cl. A61D 1/02

(52) U.S. Cl. 606/159

(57) ABSTRACT

A surgical cutting device according to the invention which permits the precise slitting of a human vein in situ. The cutting device is supported and guided over the centerline of the vein to be slit by two generally opposing guides which serve to precisely orient the knife along the centerline of the vein. The cutting device can comprise a blade or a functionally equivalent cutting edge or surface and is useful to cut other human vessels such as arteries or ducts.

### CROSS-REFERENCE TO RELATED APPLICATION

This application is based upon co-pending U.S. provisional patent application Serial No. 60/302,411, filed Jun. 29, 2001.

### FIELD OF THE INVENTION

The present invention relates to the field of surgical cutting implements. More particularly, the invention to the field of surgical knives having a specific purpose.

### BACKGROUND OF THE INVENTION

In carrying out carious surgical procedures, it is often necessary for one reason or another to longitudinally slit a vein, i.e., to remove a restriction or to provide access. In doing so, the surgeon is faced with the problem of having to slit a rather narrow and often times unstable vein with a surgical knife which could, and often does, easily slide and cut at an odd angle or, worse, cut diagonally through the vein which the surgeon is attempting to slit.

The foregoing scenario is compounded by the fact that the vein to be slit may already have a guidewire placed within it, making slitting the vein in any precise manner all the more difficult.

A number of prior art references are available in the art, each of which references is directed to some specific discreet element of the system which is described and claimed in the present invention. The following prior art references are known:

U.S. Pat. No. 5,769,866, which issued to Frantzen on Jun. 23, 1998, teaches an incision device for precisely initiating and controlling the depth of an incision;

U.S. Pat. No. 4,586,924, which issued to Lanning on May 6, 1986, is directed to a vein constrictor and immobilizer device to allow for easier insertion of a needle into the vein;

U.S. Pat. No. 4,001,934, which issued to Bell on Jan. 11, 1977, teaches a non-surgical cutter for rolled coins, including a bifurcated section for receiving the rolled coins;

U.S. Pat. No. 3,610,246, which issued to Salmon on Oct. 5, 1971, is directed to a surgical knife which is specifically designed to cut a membrane;

U.S. Pat. No. 3,324,854, which issued to Weese on Jun. 13, 1967, teaches an apparatus for facilitating the insertion of a hypodermic needle into the vein of a human being;

U.S. Pat. No. 2,776,480, which issued to Abel on Jan. 8, 1957, discloses a non-surgical cutting device having a slitter capable of cutting through tissue, such as in a vein.

None of these references teaches the device of the invention which permits the easy and precise slitting of a vessel in situ within the human body by employing a surgical knife which is supported and guided over the center line of the vessel to be slit by two generally opposing guides which serve to precisely orient the knife along the center line of said vessel.

### OBJECTS OF THE INVENTION

It is an object of the invention to provide a surgical knife in combination with a cutting guide.

It is also an object of the invention to provide a surgical knife which allows the surgeon to precisely slit a human vessel, e.g., artery, vein or duct, with ease.

It is a further object of the invention to enable a user to precisely slit a human vessel without the need for the application of a high degree of skill.

These and other objects of the invention will become apparent from the discussion below.

### SUMMARY OF THE INVENTION

The present invention provides for a surgical knife which permits the precise slitting of a human vessel such as a vein in situ. The surgical knife is supported and guided over the center line of the vein to be slit by two generally opposing guides which serve to precisely orient the knife along the center line of the vein. The supporting guides provided for in the surgical knife device of the invention allow a user of limited skill to precisely slit a human vein without encountering the problems typically associated with such procedures and normally experienced by the less skilled user.

The construction and obvious advantages provided for by the present invention will be more clearly understood from the following description of the various specific embodiments when read in conjunction with accompanying drawings.

### BRIEF DESCRIPTION OF THE DRAWINGS

FIG. 1 is a front elevational view of the surgical cutting knife and supporting guides according to the invention;

FIG. 2 is a side elevational view of the surgical cutting knife and supporting guides shown in FIG. 1;

FIG. 3 is a top view of the surgical cutting knife and supporting guides shown in FIG. 1;

FIG. 4 is a front elevational view of the surgical cutting knife and supporting guides shown in FIG. 1, with the device placed over the center line of a human vessel through which a guidewire/catheter has been inserted;

FIG. 5 is a side elevational view of the surgical cutting knife, supporting guides, vessel and guidewire shown in FIG. 4;

FIG. 6 is a top view of the surgical cutting knife, supporting guides, vessel and guidewire shown in FIG. 4.

### DETAILED DESCRIPTION OF THE INVENTION

The present invention is directed to a surgical knife which permits the precise slitting of a human vessel in situ. The surgical knife which is supported by and guided over the center line of the vessel by two generally opposing guides located on either side of the knife blade. These guides serve to precisely orient the knife along the centerline of the vessel. Typical vessels include veins, arteries, and ducts.

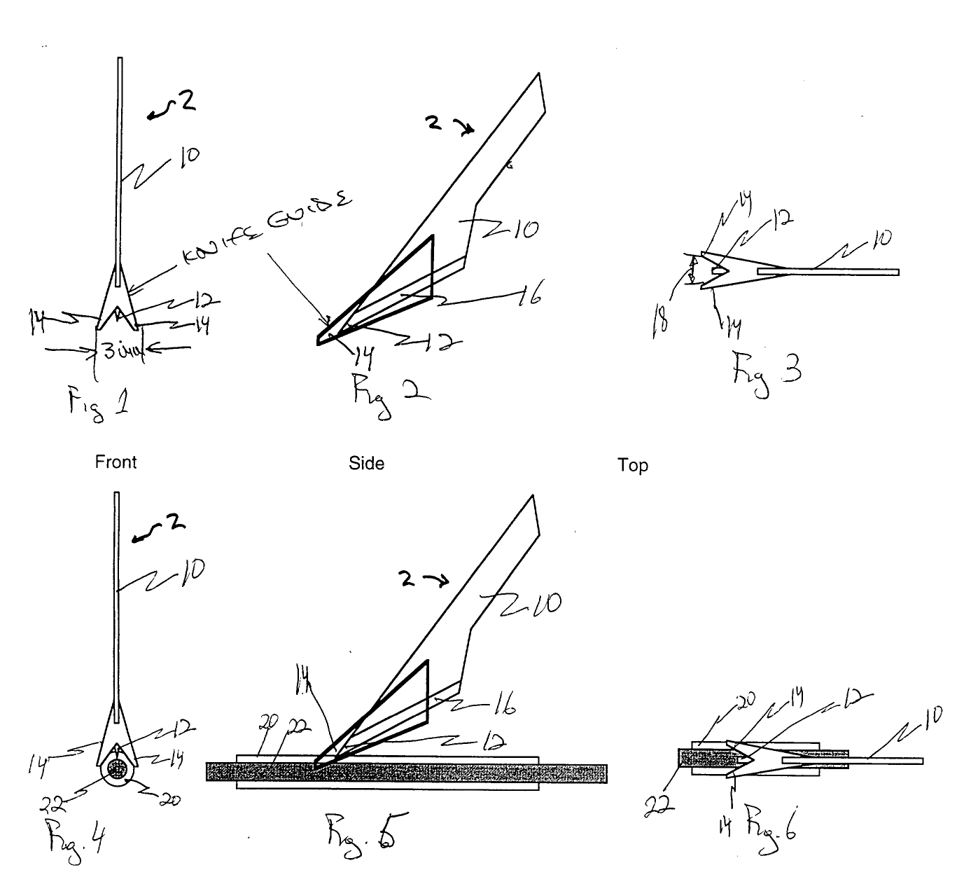

The invention can perhaps be better understood from the drawings. FIG. 1 represents a front elevational view of a surgical cutting knife 2 comprising a body 10 having a cutting tip 12 on one end. Located on either side of cutting tip 12 are two generally opposing supporting guides 14 which, together with cutting tip 12, form a tripod arrangement such that when cutting tip 12 is located on the surface of a vessel to be slit, supporting guides 14 are resting on the outer surface of the vessel and cause cutting tip 12 to be precisely centered on the vein.

FIG. 2, which shows a side elevational view of the surgical cutting knife 2 depicted in FIG. 1, illustrates a preferred arrangement for guides 14 with relation to cutting tip 12 which is part of a cutting edge 16 that is part of body 10.

As shown in FIGS. 1 and 2, guides 14 are preferably generally triangular in shape and are attached to body 10 of cutting knife 2 at a point above cutting edge 16 such that supporting guides 14 generally form an opening directly above and centered upon the tip 12 of cutting edge 16 to allow tip 12 free access to a vessel to be slit while permitting supporting guides 14 a supporting surface to rest on the outer surface of the vessel.

FIG. 3 depicts a top view of the surgical cutting knife 2 shown in FIGS. 1 and 2 and shows the top of cutting tip 12, the supporting guides 14, as well as an open space 18 formed between.

FIG. 4 shows a front elevation of the surgical cutting knife 2 of FIGS. 1-3, with the opposing supporting guides 14 resting upon the outer surface of a vessel 20. Cutting tip 12 pierces the centerline of vessel 20 into which a guidewire/catheter 22 has been inserted.

FIG. 5 depicts a side elevational view of the surgical cutting knife 2 of FIGS. 1-3 with the cutting tip 12 positioned over vessel 20 and guided by guides 14 to precisely position cutting edge 16 and tip 12.

Cutting edge 16 of knife 2 may be constructed of any rigid, sterilizable material capable of being sharpened or formed to present a sharp edge. Useful materials include any suitable metal, such as, for example, stainless steel or an alloy thereof, as will be known to one skilled in this art. It is within the scope of the invention that the knife could comprise a functional equivable of a cutting edge, such as a laser beam or an electrothermal or electrosurgical surface or wire.

Supporting guides 14 may be constructed out of any known physiologically acceptable inert material such as, for example, polypropylene, nylon, TEFLON® or another similar material which will not serve to interact with body fluids during surgery. The precise material of construction and dimensions of the supporting guides is not critical so long as the physical arrangement of the supporting guides and the cutting tip is such that the necessary tripod arrangement is formed with sufficient open access between the supporting guides to allow the inner surfaces thereof to rest on the outer surface of the vein and permit good cutting contact between the tip 12 and the surface of the vessel 20.

It will be further apparent to one skilled in this art that the improvements provided for in the present invention, while described with relation to certain specific physical embodiments also lend themselves to being applied in other physical arrangements not specifically provided for herein, which are nonetheless with the spirit and scope of the invention taught here.

I claim:

1. A surgical device for slitting a human vessel having a centerline lengthwise comprising:
a surgical cutting means having a cutting edge or surface, and
two generally opposing guides oriented with relation to said cutting means such that the two opposing guides support and precisely orient the cutting edge or surface of the cutting means directly over the centerline of the vessel.

2. The surgical device of claim 1, wherein the cutting means is a blade housing a cutting edge.

3. The surgical device of claim 1, wherein two opposing guides are attached to the body of the device at a point above the cutting edge or surface.

4. The surgical device of claim 1, wherein the cutting edge or surface has a tip.

5. The surgical device according to claim 4, wherein the cutting edge or surface is angled with relation to the plane of an operative surface of the vessel to be slit and the two opposing supporting guides are attached to the body of the device at a point above the cutting edge or surface, such that the tip of the cutting edge or surface and the ends of the two support guides create a tripod arrangement.

6. The surgical device of claim 4, wherein the two supporting guides are oriented such that they form an opening between them, which opening lies directly above and is centered upon the tip of the cutting edge or surface.

7. The surgical device of claim 4, wherein the two supporting guides are attached to the body of the device at a point above the cutting edge or surface, such that the tip of the cutting edge or surface has free access to the surface of the vessel to be slit.

8. The surgical device of to claim 4, wherein the ends of the two supporting guides and the tip of the cutting edge or surface creates a tripod arrangement whose geometry is such that when the ends of the guides are resting upon the outer surface of the vessel to be slit, the tip of the cutting edge is positioned along the center line of said vessel.

9. The surgical device of claim 1, wherein the vessel is an artery, vein, or duct.

10. The surgical device of claim 9, wherein the vessel is a vein.

11. The surgical device of claim 2, wherein the knife blade is constructed from a material selected from the group comprising stainless steel and stainless steel alloys

12. The surgical device of claim 1, wherein the cutting means comprises a laser, thermal, or electrothermal cutter.

13. The surgical device of claim 1, wherein the supporting guides are constructed of a physiologically acceptable inert material.

14. The surgical device of claim 13, wherein the supporting guides are constructed from a material selected from the group consisting of polypropylene, nylon, TEFLON®, and co-polymers thereof and other similar materials.
